(19) United States
(12) Patent Application Publication
(10) Pub. No.: US 2023/0177797 A1
(43) Pub. Date: Jun. 8, 2023

(54) MODEL GENERATION SYSTEM, SHAPE RECOGNITION SYSTEM, MODEL GENERATION METHOD, SHAPERECOGNITION METHOD, AND COMPUTER PROGRAM

(71) Applicant: NEC Corporation, Minato-ku, Tokyo (JP)

(72) Inventor: Masashi FUJITSUKA, Tokyo (JP)

(73) Assignee: NEC Corporation, Minato-ku, Tokyo (JP)

(21) Appl. No.: 17/919,779

(22) PCT Filed: Apr. 24, 2020
(86) PCT No.: PCT/JP2020/017739

§ 371 Date: Oct. 19, 2022

(51) Int. Cl. G06V 10/422; G06V 10/764; G06T 7/90

(52) U.S. Cl. CPC G06V 10/422; G06V 10/764; G06T 7/90

(57) ABSTRACT

A model generation system includes: an extraction unit that extracts an object area part, which is an area occupied by an object, from a target image; and a generation unit that performs machine learning by inputting the object area part and that generates a shape classification model for classifying a shape of the object. The use of the shape classification model generated in this manner makes it possible to properly recognize the shape of the object in the image.

### TECHNICAL FIELD

The present invention relates to a model generation system, a shape recognition system, a model generation method, a shape recognition method, and a computer program for recognizing a shape of an object.

### BACKGROUND ART

A known system of this type recognizes an object in an image. For example, Patent Literature 1 discloses a technique/technology of identifying an object by using features of objects (texture, color, shape, boundary, etc.). As another related art, Patent Literature 2 discloses a technique/technology of inferring the same object from the shape of objects. Patent Literature 3 discloses a technique/technology of searching for an image by using a similarity degree of an object in the image.

### CITATION LIST

### Patent Literature

Patent Literature 1: JP2020-507855A

Patent Literature 2: JP2019-070467A

Patent Literature 3: JPH10-240771A

### SUMMARY

### Technical Problem

In order to recognize the shape of an object, a method of performing machine learning by using information about the shape is considered. In the technique/technology as described in Patent Literature 1, however, it is extremely hard to allow the learning by capturing only the feature of the shape from among various features, such as a difference in background in an image and a difference in color of objects. That is, even if the above-described technique/technology is applied, it is not easy to construct a system for properly recognizing the shape of an object.

In view of the above problems, it is an example object of the present invention to provide a model generation system, a shape recognition system, a model generation method, a shape recognition method, and a computer program that are configured to properly recognize the shape of an object.

### Solution to Problem

A model generation system according to an example aspect of the present invention includes: an extraction unit that extracts an object area part, which is an area occupied by an object, from a target image; and a generation unit that performs machine learning by inputting the object area part and that generates a shape classification model for classifying a shape of the object.

A shape recognition system according to an example aspect of the present invention includes: an extraction unit that extracts an object area part, which is an area occupied by an object, from a target image; and an estimation unit that estimates a shape of the object in the object area part, by using a shape classification model for classifying the shape of the object.

A model generation method according to an example aspect of the present invention includes: extracting an object area part, which is an area occupied by an object, from a target image; and performing machine learning by inputting the object area part and generating a shape classification model for classifying a shape of the object.

A shape recognition method according to an example aspect of the present invention includes: extracting an object area part, which is an area occupied by an object, from a target image; and estimating a shape of the object in the object area part, by using a shape classification model for classifying the shape of the object.

A computer program according to an example aspect of the present invention operates a computer: to extract an object area part, which is an area occupied by an object, from a target image; and to perform machine learning by inputting the object area part and to generate a shape classification model for classifying a shape of the object.

A computer program according to an example aspect of the present invention operates a computer: to extract an object area part, which is an area occupied by an object, from a target image; and to estimate a shape of the object in the object area part, by using a shape classification model for classifying the shape of the object.

### Effect of the Invention

According to the model generation system, the shape recognition system, the model generation method, the shape recognition method, and the computer program in respective example aspects, it is possible to properly recognize the shape of an object.

### BRIEF DESCRIPTION OF DRAWINGS

FIG. 1 is a block diagram illustrating a hardware configuration of a model generating system according to a first example embodiment.

FIG. 2 is a block diagram illustrating a functional block provided by the model generating system according to the first example embodiment.

FIG. 3 is a conceptual diagram illustrating extraction of an object area part using an instance segmentation model.

FIG. 4 is a flowchart illustrating a flow of operation of the model generating system according to the first example embodiment.

FIG. 5 is a block diagram illustrating a functional block provided by a model generating system according to a second example embodiment.

FIG. 6 is a flowchart illustrating a flow of operation of the model generating system according to the second example embodiment.

FIG. 7 is a block diagram illustrating a functional block provided by a shape recognition system according to a third example embodiment.

FIG. 8 is a flowchart illustrating a flow of operation of the shape recognition system according to the third example embodiment.

FIG. 9 is a conceptual diagram illustrating a specific operation example of the shape recognition system according to the third example embodiment.

FIG. 10 is version 1 of a diagram illustrating a specific output example of the shape recognition system according to the third example embodiment.

FIG. 11 is version 2 of a diagram illustrating a specific output example of the shape recognition system according to the third example embodiment.

FIG. 12 is a block diagram illustrating a functional block provided by a shape recognition system according to a fourth example embodiment.

FIG. 13 is a flowchart illustrating a flow of operation of the shape recognition system according to the fourth example embodiment.

FIG. 14 is a flowchart illustrating a flow of operation of a shape recognition system according to a modified example.

### DESCRIPTION OF EXAMPLE EMBODIMENTS

Hereinafter, a model generation system, a shape recognition system, a model generation method, a shape recognition method, and a computer program according to example embodiments will be described with reference to the drawings.

### First Example Embodiment

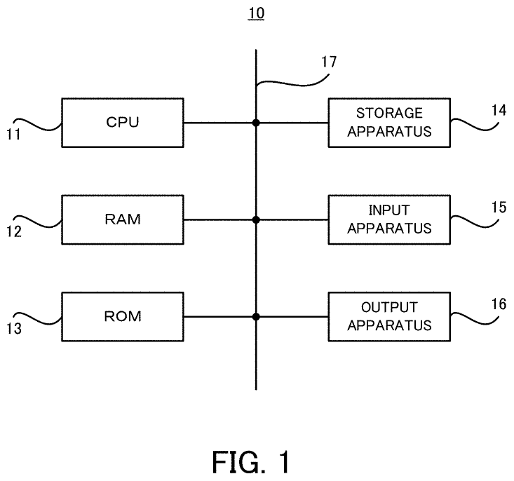

First, a model generation system according to a first example embodiment will be described with reference to FIG. 1 to FIG. 4.

### Hardware Configuration

With reference to FIG. 1, a hardware configuration of the model generation system according to the first example embodiment will be described. FIG. 1 is a block diagram illustrating the hardware configuration of the model generation system according to the first example embodiment.

As illustrated in FIG. 1, a model generating system 10 according to the first example embodiment includes a CPU (Central Processing Unit) 11, a RAM (Random Access Memory) 12, a ROM (Read Only Memory) 13, and a storage apparatus 14. The model generation system 10 may further include an input apparatus 15 and an output apparatus 16. The CPU 11, the RAM 12, the ROM 13, the storage apparatus 14, the input apparatus 15, and the output apparatus 16 are connected through a data bus 17.

The CPU 11 reads a computer program. For example, the CPU 11 is configured to read a computer program stored in at least one of the RAM 12, the ROM 13 and the storage apparatus 14. Alternatively, the CPU 11 may read a computer program stored by a computer readable recording medium by using a not-illustrated recording medium reading apparatus. The CPU 11 may obtain (i.e., read) a computer program from a not-illustrated apparatus located outside the model generation system 10 through a network interface. The CPU 11 controls the RAM 12, the storage apparatus 14, the input apparatus 15, and the output apparatus 16 by executing the read computer program. Especially in the first example embodiment, when the CPU 11 executes the read computer program, a functional block for generating a shape classification model for identifying a shape of an object is realized in the CPU 11.

The RAM 12 temporarily stores the computer program to be executed by the CPU 11. The RAM 12 temporarily stores the data that is temporarily used by the CPU 11 when the CPU 11 executes the computer program. The RAM 12 may be, for example, a D-RAM (Dynamic RAM).

The ROM 13 stores the computer program to be executed by the CPU 11. The ROM 13 may otherwise store fixed data. The ROM 13 may be, for example, a P-ROM (Programmable ROM).

The storage apparatus 14 stores the data that is stored for a long term by the model generation system 10. The storage apparatus 14 may operate as a temporary storage apparatus of the CPU 11. The storage apparatus 14 may include, for example, at least one of a hard disk apparatus, a magneto-optical disk apparatus, an SSD (Solid State Drive), and a disk array apparatus.

The input apparatus 15 is an apparatus that receives an input instruction from a user of the model generation system 10. The input apparatus 15 may include, for example, at least one of a keyboard, a mouse, and a touch panel.

The output apparatus 16 is an apparatus that outputs information about the model generation system 10 to the outside. For example, the output apparatus 16 may be a display apparatus (e.g., a display) that is configured to display the information about the model generation system 10.

### System Configuration

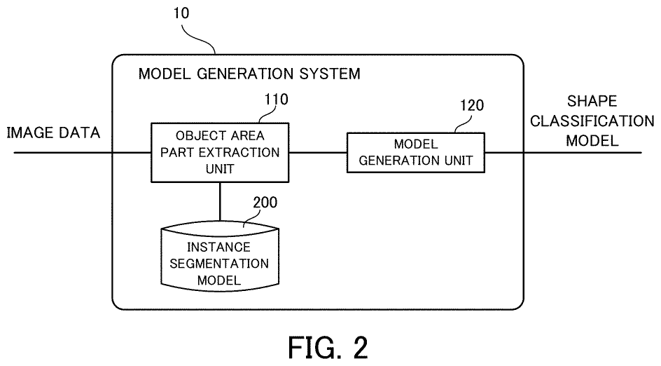

Next, a functional configuration of the model generation system 10 according to the first example embodiment will be described with reference to FIG. 2. FIG. 2 is a block diagram illustrating a functional block provided by the model generating system according to the first example embodiment.

As illustrated in FIG. 2, the model generation system 10 according to the first example embodiment includes an object area part extraction unit 110 and a model generation unit 120. These functional blocks are realized, for example, in the CPU 11 (see FIG. 1).

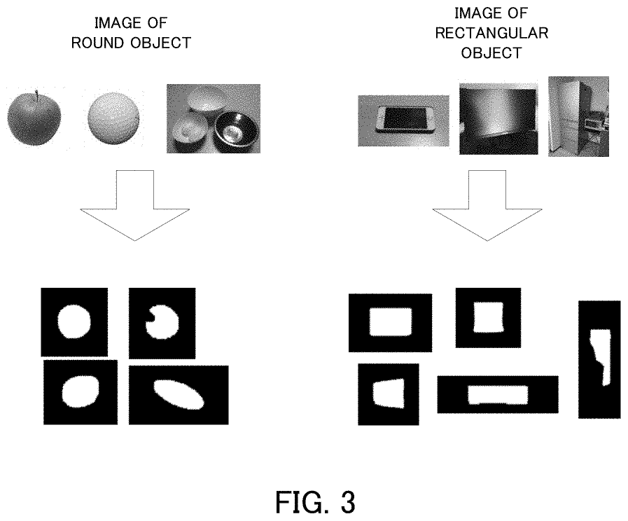

The object area part extraction unit 110 is configured to extract an object area part that is an area occupied by an object of a predetermined shape (in other words, a shape to be recognized), from image data inputted to the system. The object area part extraction unit 110 uses an instance segmentation model 200 to extract the object area part. Referring now to FIG. 3, a method of extracting the object area part by using the instance segmentation model 200 will be described. FIG. 3 is a conceptual diagram illustrating the extraction of the object area part using the instance segmentation model.

As illustrated in FIG. 3, the use of the instance segmentation model 200 makes it possible to extract only the object area part from an image including the object. For example, from an image of a round object, such as an apple or a golf ball, a mask image obtained by cutting only an area occupied by the image of the round object (i.e., only a round area) can be extracted. Similarly, from an image of a rectangular object, such as a smartphone or a personal computer monitor, a mask area obtained by cutting an area occupied by the image of the rectangular object (i.e., only a rectangular area) can be extracted.

The instance segmentation model 200 is a model for extracting the object area part by processing an image in units of multiple unit regions (e.g., by processing an image in units of pixels); however, it is the existing technique/technology, and thus, a more detailed explanation thereof will be omitted here. Furthermore, although the method using the instance segmentation model is exemplified here, other methods may be used to extract the object area part.

Returning to FIG. 2, the object area part extraction unit 110 outputs the object area part extracted by using the instance segmentation model 200. Information about the object area part outputted from the object area part extraction unit 110 is configured to be outputted to the model generation unit 120. The object area part extraction unit 110 is a specific example of the “extraction unit”.

The model generation unit 120 is configured to perform machine learning by using the object area part extracted by the object area part extraction unit 110 as input data (in other words, teacher data). The model generation unit 120 generates a shape classification model for recognizing the shape of an object by this machine learning. The object area part may be manually annotated (e.g., by providing information indicating what shape the extracted shape actually is) before it is inputted to the model generation unit 120. Existing learning techniques/technologies can be applied, as appropriate, to the machine learning of the model generation unit 120. The model generation unit 120 is a specific example of the “generation unit”.

### Description of Operation

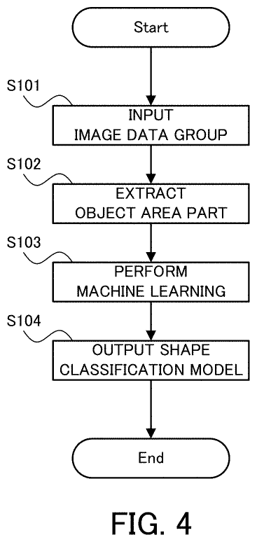

Next, a flow of operation of the model generation system 10 according to the first example embodiment will be described with reference to FIG. 4. FIG. 4 is a flowchart illustrating the flow of the operation of the model generation system according to the first example embodiment.

As illustrated in FIG. 4, first, an image data group including a plurality of image data is inputted to the model generation system 10 according to the first example embodiment (step S101). The image data group inputted here is image data obtained by imaging an object of a predetermined shape (e.g., a round object or a rectangular object) to be recognized by the shape classification model. However, all the image data do not need to include the object of the predetermined shape.

Then, the object area part extraction unit 110 extracts the object area part occupied by the object of the predetermined shape from the inputted image data group (step S102). Then, the model generation unit 120 performs the machine learning by using the extracted object area part as the input data (step S103). The model generation unit 120 outputs the shape classification model for recognizing the shape of the object, as a result of the machine learning (step S104).

### Technical Effect

Next, a technical effect obtained by the model generating system 10 according to the first example embodiment will be described.

As described in FIG. 1 to FIG. 4, in the model generation system 10 according to the first example embodiment, the object area part is extracted by using the instance segmentation model 200, and the shape classification model is generated by the machine learning in which the object area part is inputted. By using the shape classification model generated in this way, the shape of the object in the image can be properly recognized. More specifically, it is possible to properly extract only the information about the shape of the object included in the image, by extracting the object area part. For example, in the mask image as illustrated in FIG. 2, another information other than the shape (e.g., information about a color and a pattern or design, etc.) is cut off, and only the information about the shape of the object is reliably extracted. In addition, it is easy to determine even the shape of objects that overlap each other in the image (i.e., objects whose shapes are hardly distinguished due to the overlap), by extracting only the object area part. Therefore, according to the model generation system 10 in the first example embodiment, it is possible to generate the shape classification model that allows the shape of the object to be properly recognized.

Furthermore, especially in the first example embodiment, the generation of the shape classification model by inputting the object area part makes it possible to realize such recognition that allows the ambiguity of the shape. Specifically, it is possible to recognize an ambiguous shape, such as a supposedly round shape, a supposedly rectangular shape (i.e., a shape that is not a rectangle nor a circle).

### Second Example Embodiment

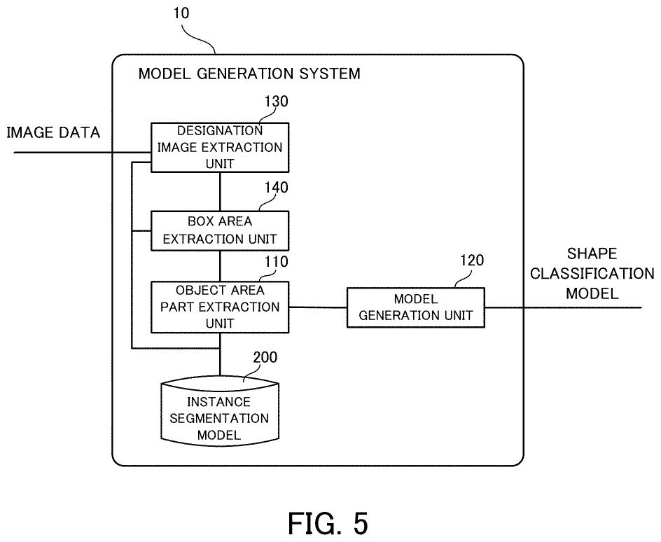

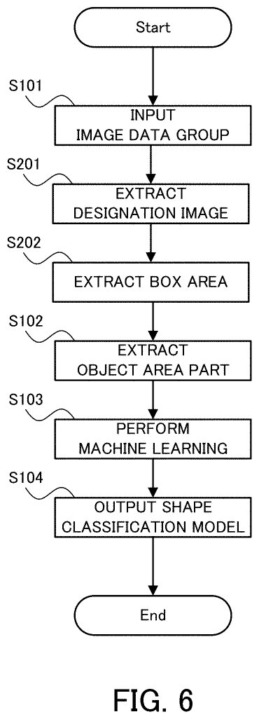

Next, the model generation system 10 according to a second example embodiment will be described with reference to FIG. 5 and FIG. 6. The second example embodiment is partially different from the first example embodiment described above only in configuration and operation, and is generally the same in the other part. Therefore, the parts that differ from the first example embodiment will be described in detail below, and the other overlapping parts will not be described as appropriate.

### System Configuration

First, a functional configuration of the model generation system 10 according to the second example embodiment will be described with reference to FIG. 5. FIG. 5 is a block diagram illustrating the functional block of the model generation apparatus according to the second example embodiment. In FIG. 5, the same components as those illustrated in FIG. 2 carry the same reference numerals.

As illustrated in FIG. 5, the model generation system 10 according to the second example embodiment includes the object area part extraction unit 110, the model generation unit 120, a designation image extraction unit 130, and a box area extraction unit 140. That is, the model generation system 10 according to the second example embodiment further includes the designation image extraction unit 130 and the box area extraction unit 140 in addition to the configuration of the first example embodiment (see FIG. 2).

The designation image extraction unit 130 is configured to extract only an image including an object of a predetermined shape to be recognized, from among the image data group inputted to the model generating system 10 (i.e., a plurality of image data). The designation image extraction unit 130 may be configured to designate the predetermined shape. In this case, for example, when the user designates the predetermined shape (or shapes), the designation image extraction unit 130 extracts only an image including an object of the designated predetermined shape (hereinafter referred to as a “designation image” as appropriate). More specifically, for example, when the user designates a “round” shape, only an image including a round object, such as an apple or a ball, is extracted from a plurality of images. The designation image extraction unit 130 extracts the designation image by using the instance segmentation model 200. However, the designation image extraction unit 130 may extract the designation image without using the instance segmentation model 200. The designation image extracted by the designation image extraction unit 130 is configured to be outputted to the box area extraction unit 140. The designation image extraction unit 130 is a specific example of the “third extraction unit”.

The box area extraction unit 140 is configured to extract a box area indicating the position of an object in the image (specifically, a rectangular area surrounding the object) from the designation image extracted by the designation image extraction unit 130 (i.e., the image including the object of the predetermined shape). The box area extraction unit 140 may extract a plurality of box areas from one designation image. The box area extraction unit 140 extracts the box area by using the instance segmentation model 200. However, the box area extraction unit 140 may extract the box area extraction unit 140 without using the instance segmentation model 200. The box area extracted by the box area extraction unit 140 is configured to be outputted to the object area part extraction unit 110. The box area extraction unit 140 is a specific example of the “second extraction unit”.

### Description of Operation

Next, a flow of operation of the model generation system 10 according to the second example embodiment will be described with reference to FIG. 6. FIG. 6 is a flowchart illustrating the flow of the operation of the model generation system according to the second example embodiment. In FIG. 6, the same steps as those illustrated in FIG. 4 carry the same reference numerals.

As illustrated in FIG. 6, in operation of the model generating system 10 according to the second example embodiment, first, the image data group including a plurality of image data is inputted (the step S101).

Then, the designation image extraction unit 130 extracts the designation image including the object of the predetermined shape from the inputted image data group (step S201). Then, the box area extraction unit 140 extracts the box area indicating the position of the object from the designation image (step S202).

Then, the object area part extraction unit 110 extracts the object area part occupied by the object of the predetermined shape from the extracted box area (the step S102). Specifically, the object area part extraction unit 110 extracts the object area part by processing the rectangular area extracted as the box area, for example, in units of pixels.

Then, the model generation unit 120 performs the machine learning by using the extracted object area part as the input data (the step S103). The model generation unit 120 outputs the shape classification model for recognizing the shape of the object, as a result of the machine learning (the step S104).

### Technical Effect

Next, a technical effect obtained by the model generating system 10 according to the second example embodiment will be described.

As described in FIG. 5 and FIG. 6, in the model generation system 10 according to the second example embodiment, the designation image including the object of the predetermined shape is extracted from the image data group, and the box area indicating the position of the object is extracted from the designation image. In this way, the object area part can be extracted, more easily and with higher accuracy. As a result, according to the model generating system 10 in the second example embodiment, it is possible to generate the shape classification model that allows the shape of the object to be more properly recognized.

### Modified Example

The example described above describes that the information about the shape of an object is extracted by using the instance segmentation model 200, but information about a color of the object may be extracted.

For example, the use of the instrumentation segmentation model 200 makes it possible to extract the color information (e.g., R, G, and B information) about the object area part. Therefore, it is possible to provide the color information about the object (e.g., red, green, blue, yellow, white, black, etc.) from a distribution of R, G, and B on the object. In this case, if the color is almost uniformly the same on the object, one color may be used, or if various colors are distributed, a special color information such as “colorful” may be provided. Alternatively, the pattern or design may be determined from the color distribution of the object to provide information about the pattern or design of the object.

The color information described above may be provided to the information about the shape. In this case, the model generation unit 120 may learn the information about the shape of the object and the information about the color to generate a model that allows the recognition of the shape and color of the object. Alternatively, the color information may be provided in place of the information about the shape. In this case, the model generation unit 120 may learn the information about the color of the object to generate a model that allows the color of the object.

### Third Example Embodiment

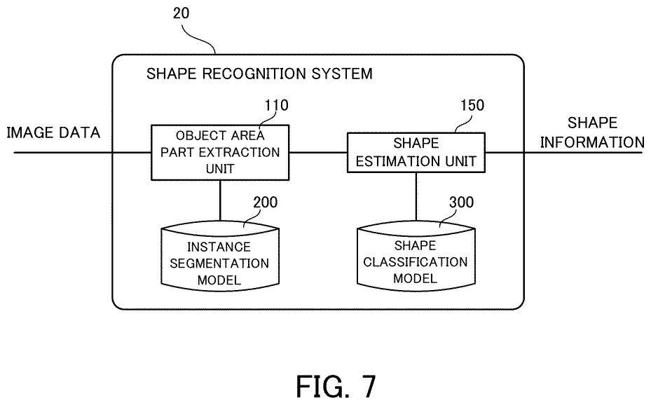

Next, a shape recognition system 20 according to a third example embodiment will be described with reference to FIG. 7 to FIG. 11. The shape recognition system 20 according to the third example embodiment partially has the same configuration and operation as those of the model generation system 10 according to the first and second example embodiments described above (e.g., a hardware configuration of the shape recognition system 20 may be the same as that of the model generation system 10 illustrated in in FIG. 1). For this reason, a description for those already described will be omitted, and non-overlapping parts will be described in detail below.

### System Configuration

First, a functional configuration of the shape recognition system 20 according to the third example embodiment will be described with reference to FIG. 7. FIG. 7 is a block diagram illustrating the functional block of the shape recognition system according to the third example embodiment. In FIG. 7, the same components those illustrated in FIG. 2 and FIG. 5 carry the same reference numerals.

As illustrated in FIG. 7, the shape recognizing system 20 according to the third example embodiment includes the object area part extraction unit 110 and a shape estimation unit 150. The object area part extraction unit 110 is the same as that of the model generating system 10 according to the first and second example embodiments (see FIG. 2 and FIG. 5), and is configured to extract the object area part from the image data by using the instance segmentation model 200.

The shape estimation unit 150 is configured to estimate the shape of the object from the object area part extracted by the object area part extraction unit 110. The shape estimation unit 150 estimates the shape of the object by using a shape classification model 300 (i.e., the model generated by the model generation system 10 according to the first and second example embodiments). The shape estimation unit 150 is a specific example of the “estimation unit”.

### Description of Operation

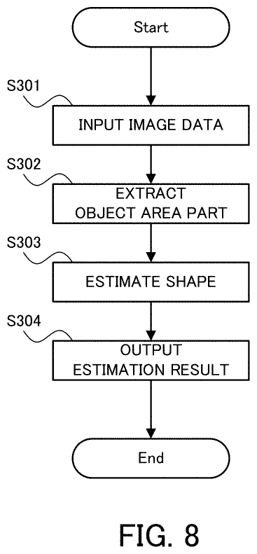

Next, with reference to FIG. 8, a flow of operation of the shape recognition system 20 according to the third example embodiment will be described. FIG. 8 is a flowchart illustrating the flow of the operation of the shape recognition system 20 according to the third example embodiment.

As illustrated FIG. 8, first, the image data are inputted to the shape recognition system 20 according to the third example embodiment (step S301). An image inputted here is an image including the object whose shape is desirably to be recognized. A plurality of images may be also inputted. In such a case, the following processing steps may be performed for each image.

Then, the object area part extraction unit 110 extracts the object area part occupied by the object of the predetermined shape from the inputted image (step S302). Then, the shape estimation unit 150 estimates the shape of the object corresponding to the extracted object area part, by using the shape classification model 300 (step S303). Finally, the shape estimation unit 150 outputs the information indicating the shape of the object as an estimation result (step S304).

The shape estimation unit 150 may output information indicating what type of predetermined shape the object corresponding to the object area part is (e.g., round, rectangular, etc.). Specifically, the shape estimation unit 150 may output a score indicating roundness of the object or a score indicating rectangularness. This score may be outputted, for example, as a numerical value indicating the probability that the object is a round object (or a rectangular object). In addition, when the object is a shape that is not classified into any of the predetermined shapes, information such as “not estimable” may be outputted.

### Specific Output Examples

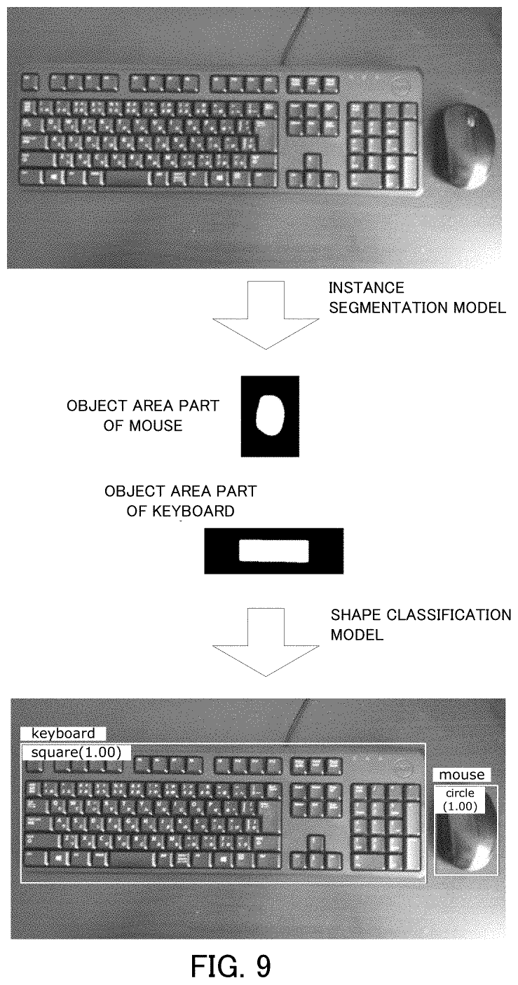

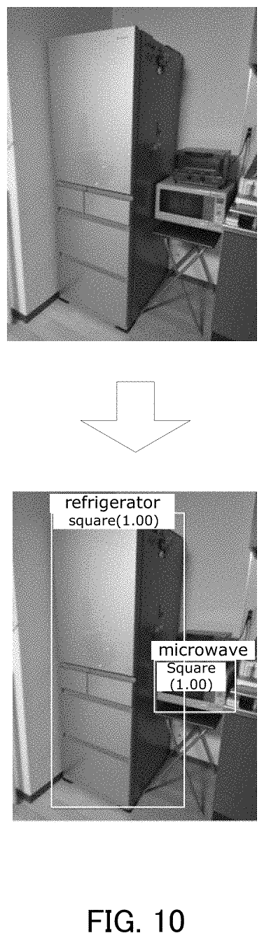

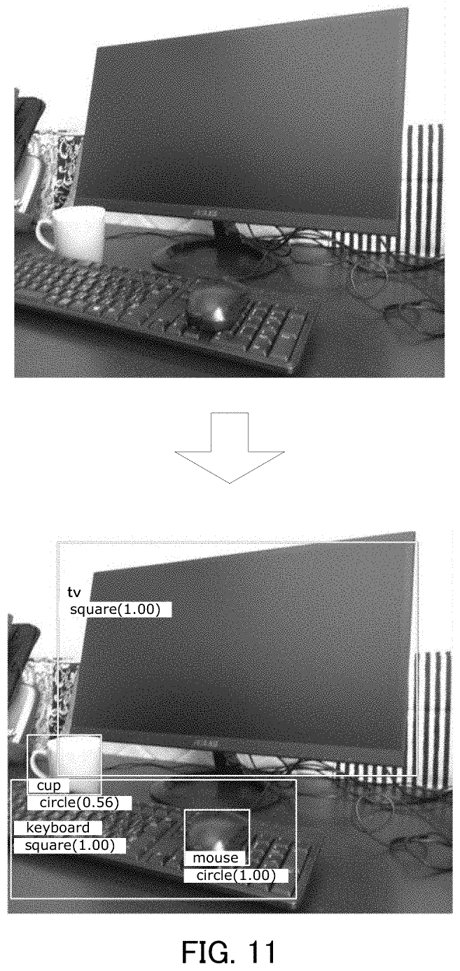

Next, a specific output example of the shape recognition system 20 according to the third example embodiment will be described with reference to FIG. 9 to FIG. 11. FIG. 9 is a conceptual diagram illustrating a specific operation example of the shape recognition system according to the third example embodiment. FIG. 10 is version 1 of a diagram illustrating a specific output example of the shape recognition system according to the third example embodiment. FIG. 11 is version 2 of a diagram illustrating a specific output example of the shape recognition system according to the third example embodiment.

The image illustrated in FIG. 9 includes a keyboard and a mouse. When the instance segmentation model 200 is applied to such an image, it is possible to extract the object area part of each of the keyboard and the mouse.

Subsequently, when the shape classification model 300 is applied to the object area part, a score (0 to 1) indicating the shape of the object corresponding to the object area part is displayed. Here, the keyboard (keyboard) scores “square (1.00)”. This means that the shape of the keyboard in the image is very close to a rectangular shape. On the other hand, the mouse (mouse) scores “circle (1.00)”. This means that the shape of the mouse in the image is very close to a round shape.

The image illustrated in FIG. 10 includes a refrigerator and a microwave oven. When the same shape recognition is performed on such an image, the refrigerator (refrigerator) scores “square (1.00)”. This means that the shape of the refrigerator in the image is very close to a rectangular shape. The microwave oven (microwave) also scores “square (1.00)”. This means that the shape of the microwave oven in the image is very close to a rectangular shape.

The image illustrated in FIG. 11 includes a monitor (TV), a keyboard, a mouse, and a cup. When the same shape recognizations is performed on such an image, the monitor (TV) scores “square (1.00)”. This means that the shape of the monitor in the image is very close to a rectangular shape. The keyboard (keyboard) also scores “square (1.00)”. This means that the shape of the keyboard in the image is very close to a rectangular shape. The mouse (mouse) scores “circle (1.00)”. This implies that the shape of the mouse in image is very close to a round shape. In addition, the cup scores “circle (0.56)”. This means that the shape of the cup in the image is slightly close to a round shape.

As described above, it is possible to intuitively understand what shape the object has, by displaying the score indicating the shape of the object. Furthermore, depending on the magnitude of the score, it is possible to determine how close it is to the round shape, or how close it is to the rectangular shape. Therefore, even if it is not a completely round shape, it may be determined to be a slightly round shape, and even if it is not a completely rectangular shape, it may be determined to be a slightly rectangular shape.

The example described above describes a case where it is recognized whether the object is round or rectangular, but a shape other than the round shape and the rectangular shape may be recognizable. For example, a triangular shape, a star shape, or a more complex shape may be recognizable.

### Technical Effect

Next, a technical effect obtained by the shape recognition system 20 according to the third example embodiment will be described.

As described in FIG. 7 to FIG. 11, in the shape recognizing system 20 according to the third example embodiment, the object area part is extracted by using the instance segmentation model 200. Then, the shape of the object is estimated by using the shape classification model 300 for the object area part. Here, the shape classification model 300 is generated as a model that allows the shape of the object to be properly recognized, as described in the first and second example embodiments. In addition, since the shape estimation is performed after extracting the object area part by using the instance segmentation model 200, it is possible to esimate the shape of the object with extremely high accuracy.

Furthermore, especially in the third example embodiment, the use of the shape classification model generated by inputting the object area part makes it possible to realize such recognition that allows the ambiguity of the shape. Specifically, it is possible to recognize an ambiguous shape, such as a supposedly round shape, a supposedly rectangular shape (i.e., a shape that is not a rectangle nor a circle).

### Fourth Example Embodiment

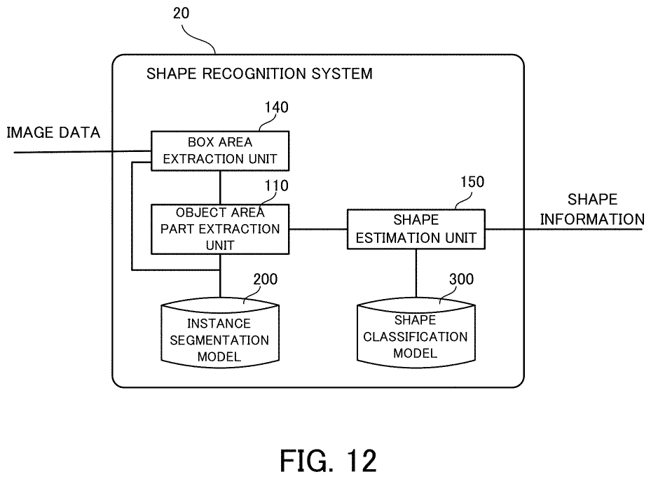

Next, the shape recognition system 20 according to a fourth example embodiment will be described with reference to FIG. 12 to FIG. 14. The fourth example embodiment is partically different from the third example embodiment described above only in configuration and operation, and is substantially the same in the other parts. Therefore, the parts that differ from the third example embodiment will be described in detail below, and the other overlapping parts will not be described as appropriate.

### System Configuration

First, a functional configuration of the shape recognition system 20 according to the fourth example embodiment will be described with reference to FIG. 12. FIG. 12 is a block diagram illustrating the functional block of the shape recognition system according to the fourth example embodiment. In FIG. 12, the same components as those illustarted in FIG. 7 carry the same reference numerals.

As illustarted in FIG. 12, the shape recognizing system 20 according to the fourth example embodiment includes the object area part extraction unit 110, the box area extraction unit 140, and the shape estimation unit 150. That is, the shape recognizing system 20 according to the fourth example embodiment further includes the box area extraction unit 140 in addition to the configuration of the third example embodiment (see FIG. 7). The box area extraction unit 140 extracts the box area indicating the position of the object from the image, as described in the second example embodiment.

### Description of Operation

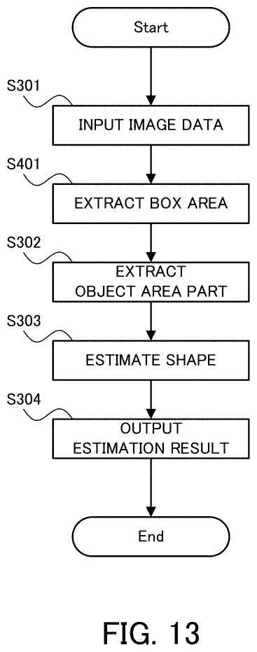

Next, a flow of operation of the shape recognition system 20 according to the fourth example embodiment will be described with reference to FIG. 13. FIG. 13 is a flowchart illustrating the flow of the operation of the shape recognition system according to the fourth example embodiment. In FIG. 13, the same steps as those illustrated in FIG. 8 carry the same reference numerals.

As illustrated in FIG. 13, in operation of the shape recognizing system 20 according to the fourth example embodiment, first, the image data are inputted (the step S301).

Then, the box area extraction unit 140 extracts the box area indicating the position of the object from the inputted image (step S401). Then, the object area part extraction unit 110 extracts the object area part occupied by the object of the predetermined shape from the extracted box area (the step S302).

Then, the shape estimation unit 150 estimates the shape of the object corresponding to the extracted object area part by using the shape classification model 300 (the step S303). Finally, the shape estimation unit 150 outputs the information indicating the shape of the object as the estimation result (the step S304).

### Technical Effect

Next, a technical effect obtained by the shape recognition system 20 according to the fourth example embodiment will be described.

As described in FIG. 12 and FIG. 13, in the shape recognizing system 20 according to the fourth example embodiment, the box area indicating the position of the object is extracted from the inputted image. In this way, the object area part can be extracted, more easily and with higher accuracy. As a result, according to the shape recognition system 20 in the fourth example embodiment, it is possible to estimate the shape of the object with higher accuracy.

### Modified Example

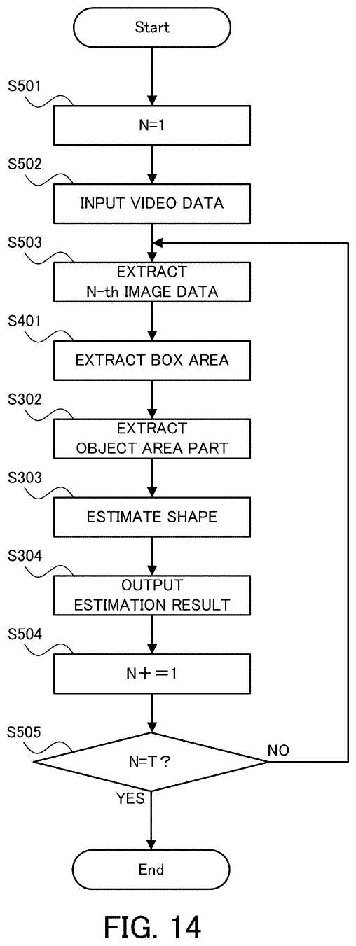

Next, the shape recognition system 20 according to a modified example of the fourth example embodiment described above will be described with reference to FIG. 14. FIG. 14 is a flowchart illustrating a flow of operation of the shape recognition system according to the modified example. In FIG. 14, the same steps as those illustrated in FIG. 13 carry the same reference numerals.

The fourth example embodiment describes an example in which the shape of the object included in the image data is estimated, but the same method may be used to estimate the shape of the object included in video data. In this case, the video data may be treated as a time-series set of a plurality of image data.

As illustrated in FIG. 14, in operation of the shape recognizing system 20 according to the modified example, first, N is set to “1”, wherein N is a parameter for counting the process repeatedly (step S501). Here, “1” is a predetermined initial value, the step S501 is a process of initializing N.

Then, the video data are inputted to the shape recognizing system 20 (step S502). The video data include T time-series image data. The shape recognition system 20 extracts N-th image data from the video data (step S503).

Then, the box area extraction unit 140 extracts the box area indicating the position of the object from the extracted N-th image (the step S401). Then, the object area part extraction unit 110 extracts the object area part occupied by the object of the predetermined shape from the extracted box area (the step S302).

Then, the shape estimation unit 150 estimates the shape of the object corresponding to the extracted object area part by using the shape classification model 300 (the step S303). Then, the shape estimation unit 150 outputs the information indicating the shape of the object as the estimation result (the step S304).

Subsequently, the shape recognition system 20 increments N (step S504). Then, the shape recognizing system 20 determines whether or not N=T (step S505). In other words, the shape recognizing system 20 determines whether or not the process is ended for the last image data included in the video data.

Here, when it is not determined that N=T (the step S505: NO), the process is performed again from the step S503. Therefore, until the process is ended for the last image data included in the video data, the step S503 to the step S504 are repeatedly performed. On the other hand, when it is determined that N=T (the step S505: YES), a series of processing steps is ended.

According to the modified example described above, it is possible to properly recognize the shape of the object included in the video data. The video data are expectedly used in a video search system due to the spread of life logs or the like. Furthermore, in order to realize a video search by free text query, it is required to respond to queries such as “When”, “Where”, “How”, and “What”.

Here, the query of “When” can be responded to by information obtained from a time stamp of a video. The query of “Where” can be responded to by GPS information (latitude/longitude information) in the video. The query of “What” can be responded to by information that can be obtained by using the existing object detection. On the other hand, the query of “How” may be hardly responded to by information that can be obtained by the existing techniques/technologies.

In contrast, according to the shape recognition system 20 in the above-described modified example, it is possible to respond to the query of “How” by using the information about the shape of the object recognized from the video data. Specifically, the user's designation of the shape of the object may be received or accepted, and the image including the object of the designated shape may be searched for and outputted from among the plurality of image data that form the video data. In this case, the user's designation of the shape may be performed, for example, by using the input apparatus 15 (see FIG. 1). Furthermore, the output of the searched image may be performed, for example, by using the output apparatus 16 (see FIG. 1). In this way, for example, a search query of “a round car seen in Kyoto in August of the last year” can be responded to by extracting an object of a “round” shape. In this way, it is conceivable that the shape recognition system 20 according to the modified example has a very useful effect in the free text query search in the video data.

### Supplementary Notes

The example embodiments described above may be further described as the following Supplementary Notes.

### Supplementary Note 1

A model generating system described in Supplementary Note 1 is a model generation system including: an extraction unit that extracts an object area part, which is an area occupied by an object, from a target image; and a generation unit that performs machine learning by inputting the object area part and that generates a shape classification model for classifying a shape of the object.

### Supplementary Note 2

A model generation system described in Supplementary Note 2 is the model generation system according to claim 1, wherein the extraction unit extracts the object area part by processing the target image in units of multiple unit regions.

### Supplementary Note 3

A model generation system described in Supplementary Note 3 is the model generation system described in Supplementary Note 1 or 2, further comprising a second extraction unit that extracts a rectangular area including the object from the target image, wherein the extraction unit extracts the object area part from the rectangular area.

### Supplementary Note 4

A model generation system described in Supplementary Note 4 is the model generation system described in any one of Supplementary Notes 1 to 3, further including: a designation unit that designates a shape classified by the shape classification model; and a third extraction unit that extracts an image including an object of the shape designated by the designation unit, as the target image from a plurality of images.

### Supplementary Note 5

A model generation system described in any one of Supplementary Notes 1 to 4 is the model generation system described in any one of Supplementary Notes 1 to 4, further comprising a color information provision unit that detects a color of the object area part and that provides a color information to the object area part.

### Supplementary Note 6

A shape recognition system described in Supplementary Note 6 is a shape recognition system including: an extraction unit that extracts an object area part, which is an area occupied by an object, from a target image; and an estimation unit that estimates a shape of the object in the object area part, by using a shape classification model for classifying the shape of the object.

### Supplementary Note 7

A shape recognition system described in Supplementary Note 7 is the shape recognition system described in Supplementary Note 6, wherein the extraction unit extracts the object area part by processing the target image in units of multiple unit regions.

### Supplementary Note 8

A shape recognition system described in Supplementary Note 8 is the shape recognition system described in Supplementary Note 6 or 7, further comprising a second extraction unit that extracts a rectangular area including the object from the target image, wherein the extraction unit extracts the object area part from the rectangular area.

### Supplementary Note 9

A shape recognition system described in any one of Supplementary Notes 6 to 8 is the shape recognition system according to any one of claims 6 to 8, further including: a reception unit that receives a designation of the shape of the object; and an output unit that outputs an image including an object of the designated shape from a plurality of target images, on the basis of an estimation result of the estimation unit.

### Supplementary Note 10

A shape recognition system described in Supplementary Note 10 is the shape recognition system described in any one of Supplementary Notes 6 to 9, wherein the estimation unit estimates a color of the object in the object area part, in addition to the shape of the object in the object area part.

### Supplementary Note 11

A model generation method described in Supplementary Note 11 is a model generation method including: extracting an object area part, which is an area occupied by an object, from a target image; and performing machine learning by inputting the object area part and generating a shape classification model for classifying a shape of the object.

### Supplementary Note 12

A shape recognition method described in Supplementary Note 12 is a shape recognition method including: extracting an object area part, which is an area occupied by an object, from a target image; and estimating a shape of the object in the object area part, by using a shape classification model for classifying the shape of the object.

### Supplementary Note 13

A computer program described in Supplementary Note 13 is a computer program that operates a computer: to extract an object area part, which is an area occupied by an object, from a target image; and to perform machine learning by inputting the object area part and to generate a shape classification model for classifying a shape of the object.

### Supplementary Note 14

A computer program described in Supplementary Note 14 is a computer program that operates a computer: to extract an object area part, which is an area occupied by an object, from a target image; and to estimate a shape of the object in the object area part, by using a shape classification model for classifying the shape of the object.

This disclosure is not limited to the examples described above and is allowed to be changed, if desired, without departing from the essence or spirit of the invention which can be read from the claims and the entire specification. A model generation system, a shape recognition system, a model generation method, a shape recognition method, and a computer program with such modifications are also intended to be within the technical scope of this disclosure.

### DESCRIPTION OF REFERENCE CODES

10 Model generation system
20 Shape recognition system
110 Object area part extraction unit
120 Model generation unit
130 Designation image extraction unit
140 Box area extraction unit
150 Shape estimation unit
200 Instance segmentation model
300 Shape classification model

What is claimed is:

1. A model generation system comprising:
at least one memory that is configured to store instructions; and
at least one processor that is configured to execute instructions
to extract an object area part, which is an area occupied by an object, from a target image; and
to perform machine learning by inputting the object area part and to generate a shape classification model for classifying a shape of the object.

2. The model generation system according to claim 1, wherein the processor extracts the object area part by processing the target image in units of multiple unit regions.

3. The model generation system according to claim 1, further comprising a processor that is configured to execute instructions to extract a rectangular area including the object from the target image, wherein
the processor extracts the object area part from the rectangular area.

4. The model generation system according to claim 1, further comprising a processor that is configured to execute instructions:
to designate a shape classified by the shape classification model; and
to extract an image including an object of the shape designated, as the target image from a plurality of images.

5. The model generation system according to claim 1, further comprising a processor that is configured to execute instructions to detect a color of the object area part and that provides a color information to the object area part.

6. A shape recognition system comprising:
at least one memory that is configured to store instructions; and
at least one processor that is configured to execute instructions
to extract an object area part, which is an area occupied by an object, from a target image; and
to estimate a shape of the object in the object area part, by using a shape classification model for classifying the shape of the object.

7. The shape recognition system according to claim 6, wherein the processor extracts the object area part by processing the target image in units of multiple unit regions.

8. The shape recognition system according to claim 6, further comprising a second extraction unit that extracts a rectangular area including the object from the target image, wherein
the extraction unit extracts the object area part from the rectangular area.

9. The shape recognition system according to claim 6, further comprising a processor that is configured to execute instructions:
to receive a designation of the shape of the object; and
to output an image including an object of the designated shape from a plurality of target images, on the basis of an estimation result.

10. The shape recognition system according to claim 6, wherein the processor estimates a color of the object in the object area part, in addition to the shape of the object in the object area part.

11. A model generation method comprising:
extracting an object area part, which is an area occupied by an object, from a target image; and
performing machine learning by inputting the object area part and generating a shape classification model for classifying a shape of the object.

12-14. (canceled)
